(19) United States
(12) Patent Application Publication
(10) Pub. No.: US 2006/0152004 A1
(43) Pub. Date: Jul. 13, 2006

(54) Pipe connecting structure

(76) Inventor: Yih Wenn Luo, Tainan City (TW)

Correspondence Address: PRO-TECHTOR INTERNATIONAL, 20775 Norada Court, Saratoga, CA, 95070-3018, US

(21) Appl. No.: 11/034,660

(22) Filed: Jan. 12, 2005

(51) Int. Cl. F16L 23/00

(52) U.S. Cl. 285/405; 285/406

(57) ABSTRACT

A pipe connecting structure is disclosed to include two pipe members each having a coupling flange extended around the periphery at one end, and a connecting member for joining the pipe members, the connecting member having an inside annular flange extending around the inside wall of the split body thereof, engagement blocks protruding from the inside wall and symmetrically spaced from the inside annular flange at two opposite sides, and a connecting portion that joins the two symmetrical halves of split body of the connecting member.

### BACKGROUND OF THE INVENTION

1. Field of the Invention

The present invention relates to a pipe connecting structure and more particularly to such a pipe connecting structure, which enables the user to quickly and detachably connect two pipe members together with less effort.

2. Description of the Related Art

FIG. 1 is an exploded view of a pipe connecting structure according to the prior art. According to this design, the pipe connecting structure A comprises a first pipe member 200, a second pipe member 200′, and a connecting member 100 adapted to join the first pipe member 200 and the second pipe member 200′. The first pipe member 200 has a coupling flange 201 extended around the periphery of one end thereof. The second pipe member 200′ has a coupling flange 201′ extended around the periphery of one end thereof. The connecting member 100 is shaped like a stub tube, having an inside annular flange 101 extending around the inside wall thereof and a plurality of engagement blocks 102 protruding from the inside wall and symmetrically spaced from the inside annular flange 101 at two sides. The first pipe member 200 and the second pipe member 200′ are respectively inserted into the connecting member 100 from two sides by force to force the respectively coupling flanges 201 and 201′ over and into engagement with the engagement blocks 102. After installation, it is difficult to detach the first pipe member 200 and the second pipe member 200′. When detaching the first pipe member 200 and the second pipe member 200′ from the connecting member 100, it requires much labor and time.

### SUMMARY OF THE INVENTION

The present invention has been accomplished under the circumstances in view.

According to one embodiment of the present invention, the pipe connecting structure comprises two pipe members each having a coupling flange extended around the periphery at one end, and a connecting member for joining the pipe members. The connecting member comprises an inside annular flange extending around the inside wall of the split body thereof, engagement blocks protruding from the inside wall and symmetrically spaced from the inside annular flange at two opposite sides, and a connecting portion that joins the two symmetrical halves of split body of the connecting member.

According to an alternate form of the present invention, the connecting member comprises an inside annular flange extending around the inside wall of the split body thereof, engagement blocks protruding from the inside wall and symmetrically spaced from the inside annular flange at two opposite sides, and an outer race spaced around the split body and having a plurality of inside radial ribs respectively connected to the two symmetrical halves of the split body to hold the two symmetrical halves together.

### BRIEF DESCRIPTION OF THE DRAWINGS

FIG. 1 is an exploded view of a pipe connecting structure according to the prior art.

FIG. 2 is an exploded view of a pipe connecting structure according to a first embodiment of the present invention.

FIG. 3 is a plain view of a connecting member with two crevices for the pipe connecting structure according to the first embodiment of the present invention.

FIG. 4 is a plain view of a connecting member with one crevice for the pipe connecting structure according to the first embodiment of the present invention.

FIG. 5 is a sectional view of the connecting member for the pipe connecting structure according to the first embodiment of the present invention.

FIG. 6 is a schematic end plain view, showing the connection of the connecting member with one pipe member according to the first embodiment of the present invention.

FIG. 7 is a schematic side plain view, showing the connection of the connecting member with one pipe member according to the first embodiment of the present invention.

FIG. 8 is a sectional assembly view of the first embodiment of the present invention.

FIG. 9 is an exploded view of a pipe connecting structure according to a second embodiment of the present invention.

FIG. 10 is a plain view of a connecting member for the pipe connecting structure according to the second embodiment of the present invention.

FIG. 11 is a schematic sectional side view, showing the connection of the connecting member with one pipe member according to the second embodiment of the present invention.

FIG. 12 shows an application example of the present invention.

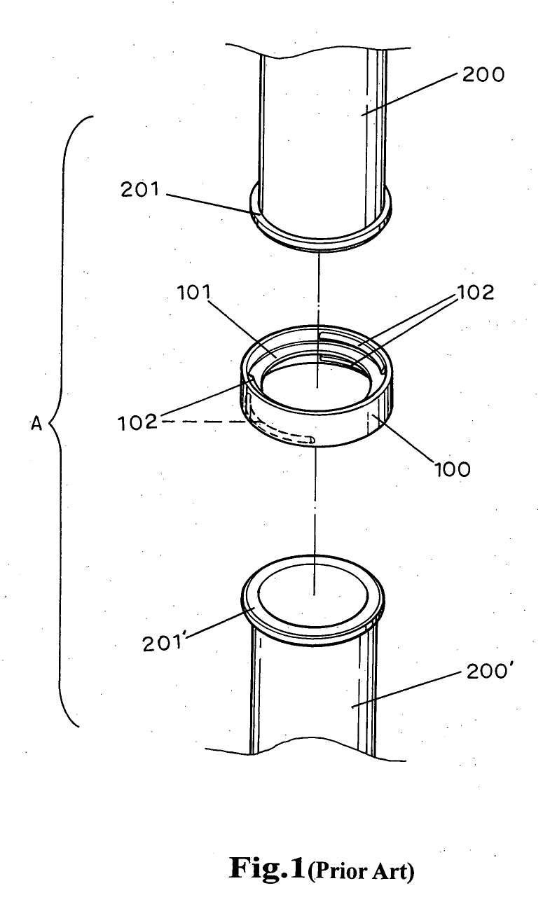

### DETAILED DESCRIPTION OF THE PREFERRED EMBODIMENT

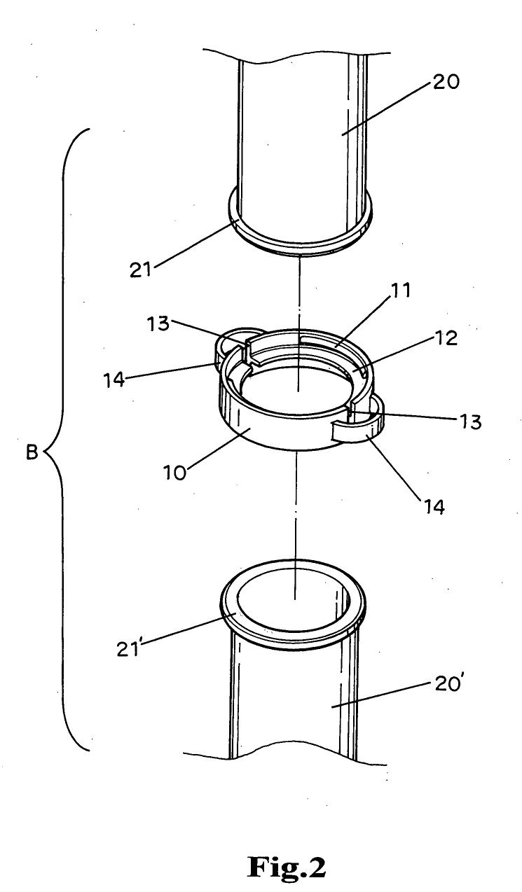

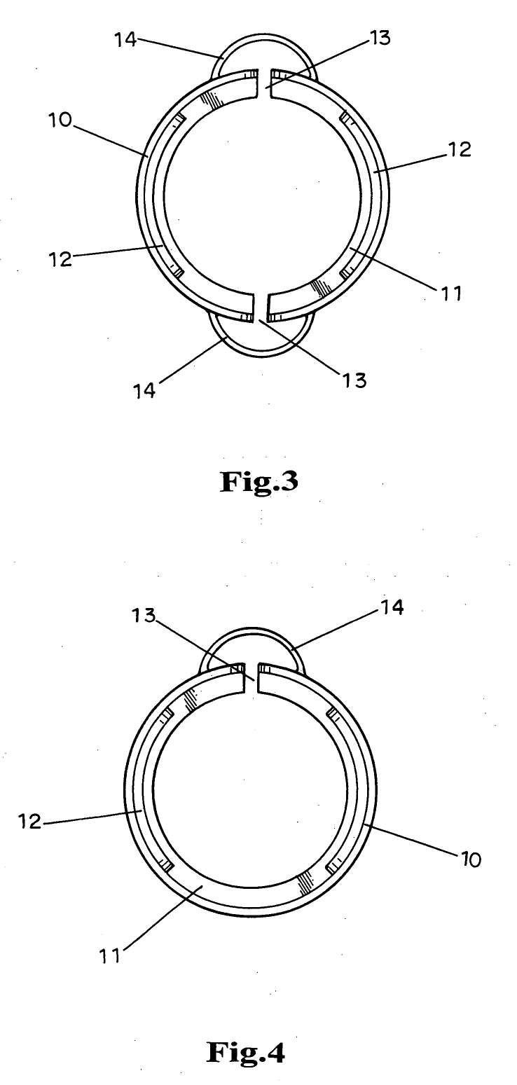

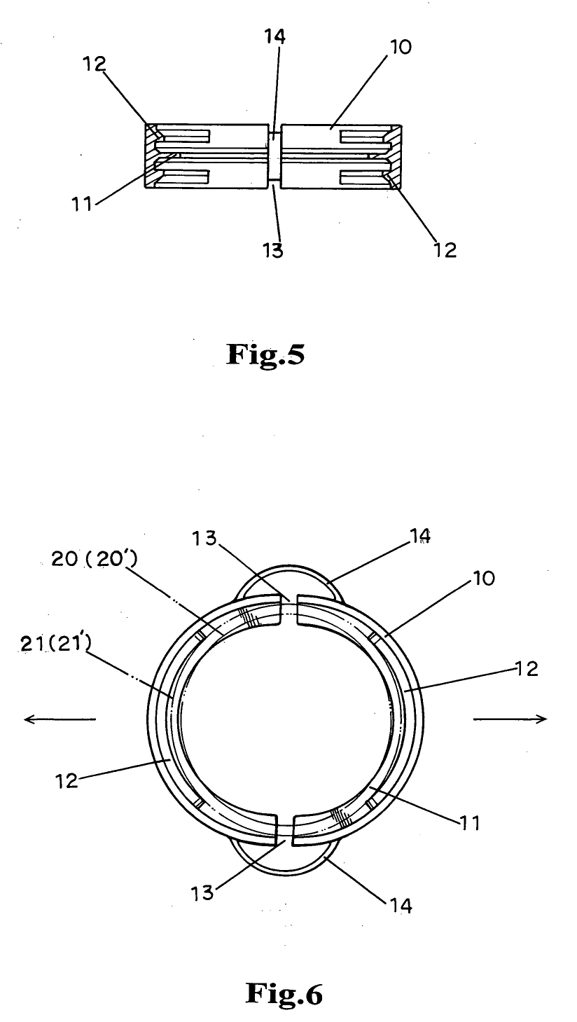

Referring to FIGS. 2˜5, a pipe connecting structure B in accordance with the first embodiment of the present invention is shown comprising a first pipe member 20, a second pipe member 20′, and a connecting member 10 adapted to join the first pipe member 20 and the second pipe member 20′. The first pipe member 20 has a coupling flange 21 extended around the periphery of one end thereof. The second pipe member 20′ has a coupling flange 21′ extended around the periphery of one end thereof. The connecting member 10 is shaped like a split stub tube, having an inside annular flange 11 extending around the inside wall thereof, a plurality of engagement blocks 12 protruding from the inside wall and symmetrically spaced from the inside annular flange 11 at two sides, at least one crevice 13 that separates the connecting member 10 into two symmetrical halves, and at least one resilient connecting portion 14 that joins the two ends of the two symmetrical halves of the connecting member 10. According to the embodiment shown in FIG. 3, the connecting member 10 has two crevices 13 and two resilient connecting portions 14. According to the embodiment shown in FIG. 4, the connecting member 10 has one crevice 13 and one resilient connecting portion 14.

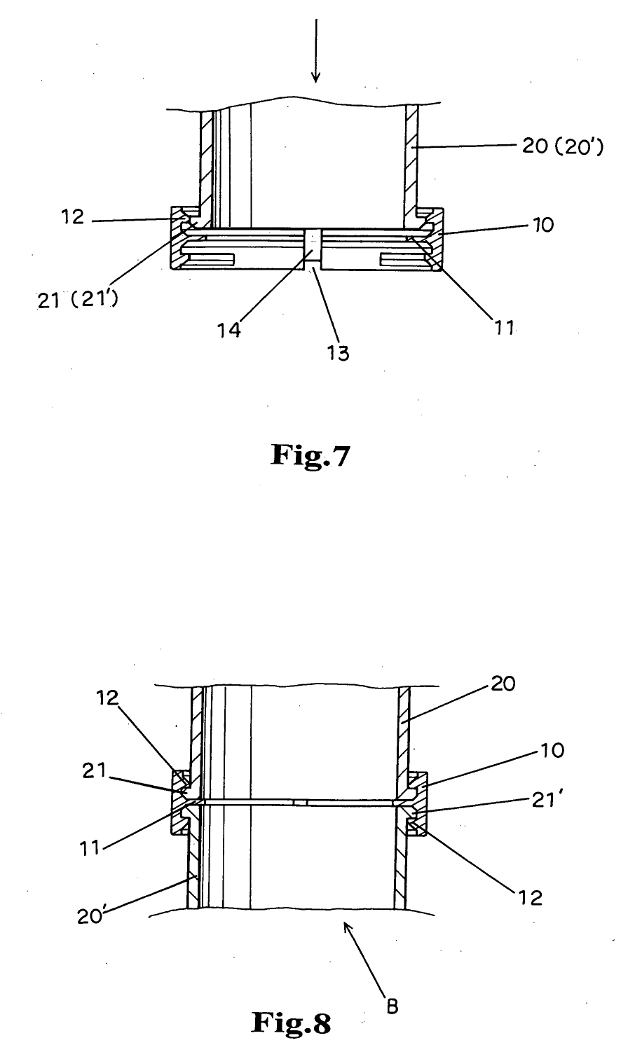

Referring to FIGS. 6˜8, the first pipe member 20 and the second pipe member 20′ are respectively inserted into the connecting member 10 from two sides by force to force the respectively coupling flanges 21 and 21′ over and into engagement with the engagement blocks 12. During insertion of one pipe member 20 or 20′ into the connecting member 10, the connecting member 10 will be expanded radially outwards for enabling the respective coupling flange 21 or 21′ to pass over the respective engagement blocks 12. When the inserted pipe member 20 or 20′ touched the inside annular flange 11, the coupling flange 21 or 21′ has been moved over the respective engagement blocks 12 and kept in engagement with the engagement blocks 12 (see FIGS. 6 and 7), and at the same time the connecting member 10 returns to its former shape, holding the coupling flange 21 or 21′ in engagement with the respective engagement blocks 12 firmly (see FIG. 8). When pulling the pipe member 20 or 20′ outwards from the connecting member 10, the coupling flange 21 or 21′ will force the two symmetrical halves of the connecting member 10 to expand radially outwards, for enabling the coupling flange 21 or 21′ to pass over the respective engagement blocks 12. Therefore, detaching the pipe members 20 and 20′ is easy.

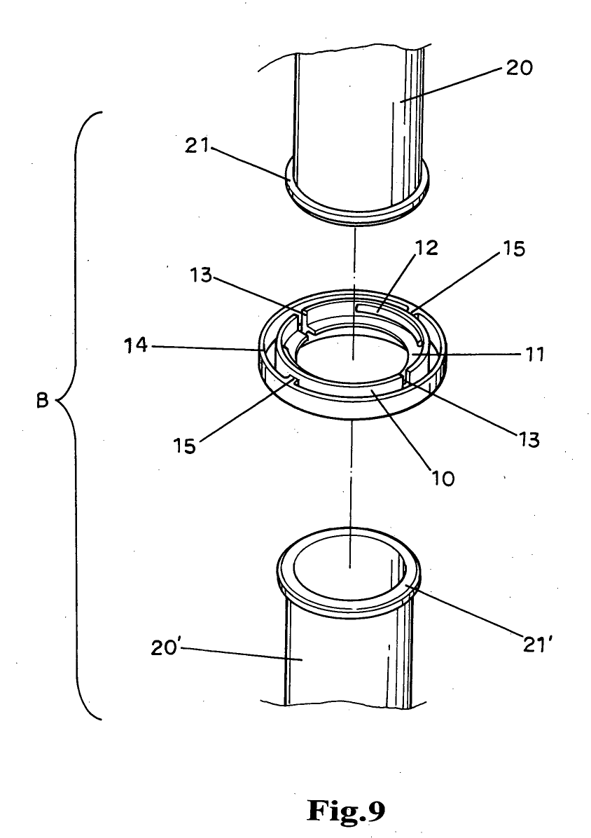

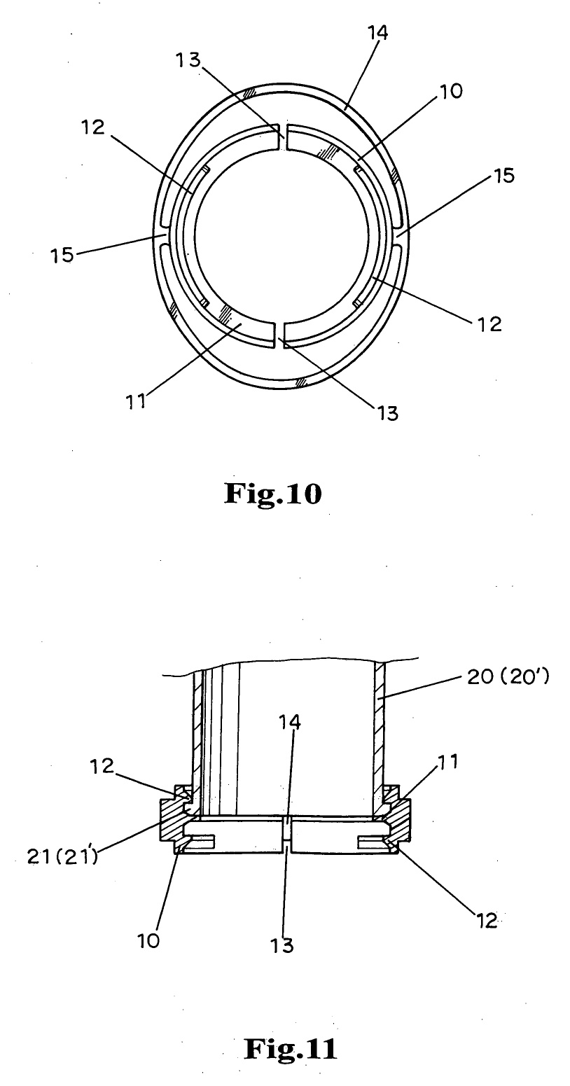

FIGS. 9˜11 show a pipe connecting structure B according to the second embodiment of the present invention. This second embodiment is substantially similar to the aforesaid first embodiment with the exception of the structure of the connecting member 10. According to this embodiment, the resilient connecting portion 14 is an outer race having inside radial ribs 15 formed connected to the two symmetrical halves of the split body of the connecting member 10. This embodiment achieves the same effect as the aforesaid first embodiment.

Further, the connecting member 10 can be made to have a triangular, rectangular, or any of a variety of polygonal cross sections that fit the cross section of the pipe members 20 and 20′.

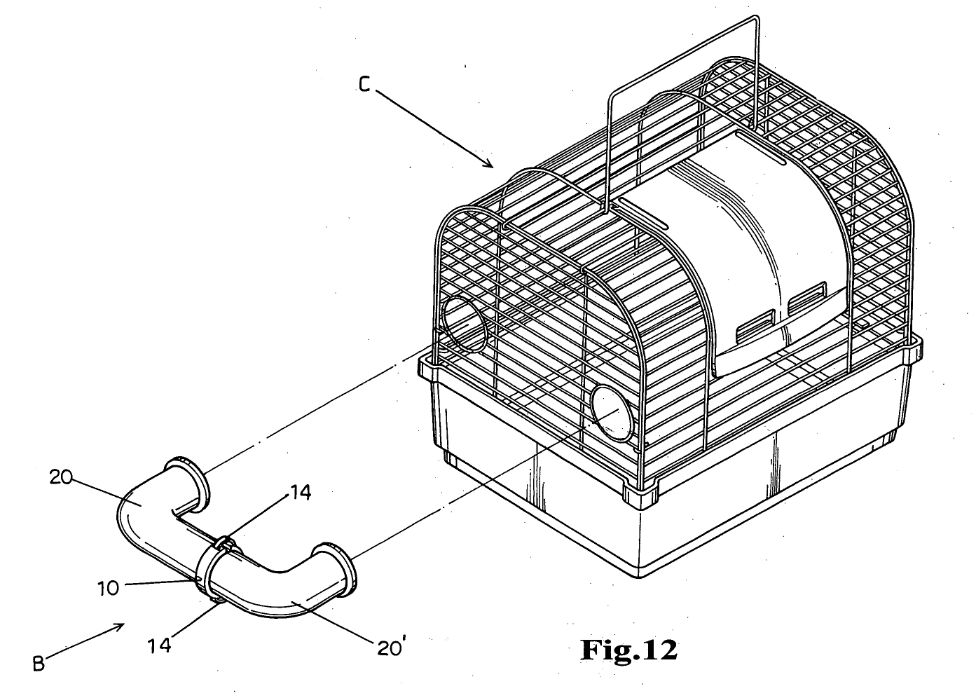

FIG. 12 shows an application example of the present invention. As illustrated, the two pipe members 20 and 20′ are connectable to a pet cage C and joined by the connecting member 10.

Further, the connecting member 10 is not limited to the application of joining the two pipe members 20 and 20′. The connecting member 10 can be used with one pipe member 20 or 20′ (see FIGS. 7 and 11). In this case, the engagement blocks 12 are provided at one side relative to the inside annular flange 11.

As indicated above, the connecting member 10 has at least one radial crevice 13 so that the split body of the connecting member 10 is radially expandable for easy insertion of the pipe member 20 or 20′ into position. After the coupling flange 21 or 21′ of the pipe member 20 or 20′ has been moved over the respective engagement blocks 12, the split body of the connecting member 10 immediately returns to its former shape, keeping the coupling flange 21 or 21′ of the pipe member 20 or 20′ in engagement with the respective engagement blocks 12 positively. Detaching the connecting member 10 from the pipe member 20 or 20′ is also simple without much effort.

Although particular embodiments of the invention have been described in detail for purposes of illustration, various modifications and enhancements may be made without departing from the spirit and scope of the invention.

What the invention claimed is:

1. A pipe connecting structure comprising at least one pipe member, each said pipe member having a coupling flange extended around the periphery of one end thereof, and a connecting member detachably connectable to the end of one said pipe member having said coupling flange, said connecting member comprising an inside annular flange extending around an inside wall thereof, and a plurality of engagement blocks protruding from said inside wall and spaced from said inside annular flange at at lease one of two opposite sides, wherein said connecting member comprises at least one crevice that separates said connecting member into two symmetrical halves, and at least one connecting portion that joins the two symmetrical halves of said connecting member.

2. A pipe connecting structure comprising at least one pipe member, each said pipe member having a coupling flange extended around the periphery of one end thereof, and a connecting member detachably connectable to the end of one said pipe member having said coupling flange, said connecting member comprising an inside annular flange extending around an inside wall of a body of, and a plurality of engagement blocks protruding from said inside wall of said body and spaced from said inside annular flange at at lease one of two opposite sides, wherein said connecting member comprises at least one crevice that separates said body into two symmetrical halves, and an outer race spaced around said body, said outer race having a plurality of inside radial ribs respectively connected to said symmetrical halves of said body.
